(19) United States
(12) Patent Application Publication
(10) Pub. No.: US 2025/0132639 A1
(43) Pub. Date: Apr. 24, 2025

(54) MOTOR COOLING SYSTEM AND MOTOR COOLING METHOD USING THE SAME

(71) Applicant: HYUNDAI MOBIS CO., LTD., Seoul (KR)

(72) Inventors: Myung Jun GAM, Gwangju-si (KR); Sang Jin KIM, Yongin-si (KR)

(73) Assignee: HYUNDAI MOBIS CO., LTD., Seoul (KR)

(21) Appl. No.: 18/903,389

(22) Filed: Oct. 1, 2024

(30) Foreign Application Priority Data
Oct. 18, 2023 (KR) 10-2023-0139414

(51) Int. Cl. H02K 9/193; H02K 11/25

(52) U.S. Cl. CPC H02K 9/193; H02K 11/25; H02K 2209/00

(57) ABSTRACT

Provided are a motor cooling system and a motor cooling method. The motor cooling system and the motor cooling method using the same may secure improved motor efficiency and output by further lowering a temperature of a drive motor cooling oil by establishing a system that achieves an improved cooling effect by changing a medium for lowering the oil temperature from an inverter or integrated charging control unit (ICCU) coolant to a refrigerant used for cooling a coolant of a battery.

### CROSS-REFERENCE TO RELATED APPLICATIONS

This application claims priority under 35 U.S.C. § 119 to Korean Patent Application No. 10-2023-0139414, filed on Oct. 18, 2023, in the Korean Intellectual Property Office, the disclosure of which is incorporated herein by reference in its entirety.

### TECHNICAL FIELD

The following disclosure relates to a motor cooling system and a motor cooling method using the same.

### BACKGROUND

In general, an electric vehicle has been developed as a precautionary measure to prevent air pollution, which is becoming more serious day by day, and with a purpose of replacing limited fluid energy with a new energy source. The electric vehicle functions as a means of transportation by driving a motor by using battery power to thus ensure its driving performance of a certain vehicle speed or more.

The electric vehicle may include a battery that generates electrical energy and a motor drive system that supplies the electrical energy generated by the battery to the motor.

As shown in FIG. 1, the motor drive system of the electric vehicle may include a power conversion part such as an inverter, an integrated charging control unit (ICCU), or a motor. The power conversion part may be equipment in which high temperature heat occurs, and the heat may occur when the inverter, the ICCU, or the motor drives the vehicle or operates electrical equipment. This heat occurrence may affect the performance and lifespan of the power conversion part, and the electric vehicle may thus include a cooling system to eliminate the heat occurrence.

The electric vehicle may adopt an oil-cooling method as its cooling method to relieve this heat occurrence, and the oil-cooling method is a method of cooling heat occurring in a motor coil of a drive motor of the electric vehicle by using oil. Here, as shown in FIG. 2, a coolant used in a water-cooled inverter or ICCU may be used to cool a cooling oil of the motor whose temperature is increased. However, the heat occurrence of the motor is greater than that of the inverter or the ICCU, and it is difficult to completely cool the motor by using the coolant used in the water-cooled inverter and ICCU to lower the heat occurrence of the motor whose power is gradually increased to around 60° C.

### Related Art Document

### Patent Document

(Patent Document 1) Korean Patent No. 10-1679927, “SYSTEM FOR COOLING IN ELECTRIC VEHICLE AND METHOD THEREOF”

### SUMMARY

An embodiment of the present disclosure is directed to providing a motor cooling system which may secure improved motor efficiency and output by further lowering a temperature of a drive motor cooling oil by establishing a system that achieves an improved cooling effect by changing a medium for lowering the oil temperature from an inverter or integrated charging control unit (ICCU) coolant to a refrigerant used for cooling a coolant of a battery, and a motor cooling method using the same.

In one general aspect, provided is a motor cooling system, which cools each component of a structure including a battery and a motor, the system including: a first oil passage part having cooling oil for cooling the motor flowing therein; a motor cooling unit including a first cooling passage having one side connected to an expansion valve and receiving a refrigerant from the expansion valve; and a heat exchange unit including a first path through which the cooling oil in the first oil passage part passes and a second path through which the refrigerant of the first cooling passage passes, wherein the first path and the second path are in direct or indirect contact with each other to exchange heat with each other.

The heat exchange unit may include a third path through which the cooling oil in a second oil passage part flows, the second oil passage part being applied to the battery and having the cooling oil for cooling the battery flowing therein, and the second path may have both sides in contact with the first path and the third path.

The heat exchange unit may include a fourth path, through which the cooling oil in a third oil passage part passes, the third oil passage part being applied to an inverter and having the cooling oil for cooling the inverter flowing therein, and a fifth path, through which the cooling oil in the first oil passage part passes and which is formed separately from the first path, and the fourth path and the fifth path may be in contact with each other to exchange heat with each other.

The motor cooling unit may include a second cooling passage through which the refrigerant supplied from the outside flows, the heat exchange unit may include a sixth path through which the refrigerant of the second cooling passage passes, and a seventh path through which the cooling oil in the first oil passage part passes and which is formed separately from the first path, and the sixth path and the seventh path may be in contact with each other to exchange heat with each other.

The system may further include: a cooling path adjustment unit applied to the first oil passage part to adjust a flow path of the cooling oil; a sensor unit attached to the motor and measuring a temperature of the motor; and a control unit controlling the cooling path adjustment unit, wherein the control unit controls the cooling path adjustment unit to adjust the flow path for the cooling oil to pass through the fifth path when the temperature of the motor that is measured by the sensor unit is less than a predetermined first reference value.

The control unit may control the cooling path adjustment unit to adjust the flow path for the cooling oil to pass through the seventh path when the temperature of the motor that is measured by the sensor unit is the first reference value or more and a temperature rise rate of the motor is a predetermined second reference value or less, and control the cooling path adjustment unit to adjust the flow path for the cooling oil to pass through the first path when the temperature of the motor that is measured by the sensor unit is the first reference value or more and the temperature rise rate of the motor is less than the predetermined second reference value.

The first oil passage parts may be applied to two or more motors, the sixth path and the seventh path may correspond one-to-one to the respective motors, the control unit may control the cooling path adjustment unit to adjust the flow path for the cooling oil to pass through the seventh path corresponding to the motor having a highest temperature when a difference between the lowest and highest temperatures of the motors that are measured by the sensor unit is a predetermined third reference value or more, control the cooling path adjustment unit to adjust the flow path for the cooling oil to pass through the first path when the difference between the lowest and highest temperatures of the motors that are measured by the sensor unit is less than the predetermined third reference value and the temperature of any one of the motors is the first reference value or more, and control the cooling path adjustment unit to adjust the flow path for the cooling oil to pass through the fifth path when the difference between the lowest and highest temperatures of the motors that are measured by the sensor unit is less than the predetermined third reference value and the temperatures of all the motors are less than the first reference value.

In another general aspect, provided is a motor cooling method using a motor cooling system applied to a structure including a battery and a motor, the method including: an operation (a) of monitoring, by a sensor unit, a temperature of the motor; an operation (b) of analyzing, by a control unit, temperature data of the sensor unit; an operation (c) of determining, by the control unit, a path of a heat exchange unit through which cooling oil passes based on the analyzed data; and an operation (d) of cooling, by the control unit, the motor by controlling a cooling path adjustment unit.

The operation (c) may include an operation (c1) of controlling the cooling path adjustment unit to adjust a flow path for the cooling oil to pass through a fifth path when the temperature of the motor that is analyzed in the operation (b) is less than a predetermined first reference value, an operation (c2) of controlling the cooling path adjustment unit to adjust the flow path for the cooling oil to pass through a seventh path when the temperature of the motor that is analyzed in the operation (b) is the first reference value or more, and a temperature rise rate of the motor is a predetermined second reference value or more, and an operation (c3) of controlling the cooling path adjustment unit to adjust the flow path for the cooling oil to pass through a first path when the temperature of the motor that is analyzed in the operation (b) is the first reference value or more, and the temperature rise rate of the motor is less than the predetermined second reference value.

The operation (c) may include an operation (c4) of controlling the cooling path adjustment unit to adjust the flow path for the cooling oil to pass through the seventh path corresponding to the motor having a highest temperature when a difference between the lowest and highest temperatures of the motors that is analyzed in the operation (b) is a third reference value or more, an operation (c5) of controlling the cooling path adjustment unit to adjust the flow path for the cooling oil to pass through the first path when the difference between the lowest and highest temperatures of the motors that are analyzed in the operation (b) is less than the predetermined third reference value and the temperature of any one of the motors is the first reference value or more, and an operation (c6) of controlling the cooling path adjustment unit to adjust the flow path for the cooling oil to pass through the fifth path when the difference between the lowest and highest temperatures of the motors that are analyzed in the operation (b) is less than the predetermined third reference value and the temperature of any one of the motors is less than the first reference value.

Other features and aspects will be apparent from the following detailed description, the drawings, and the claims.

### BRIEF DESCRIPTION OF THE DRAWINGS

FIG. 1 is a schematic diagram showing a motor drive system of a conventional electric vehicle.

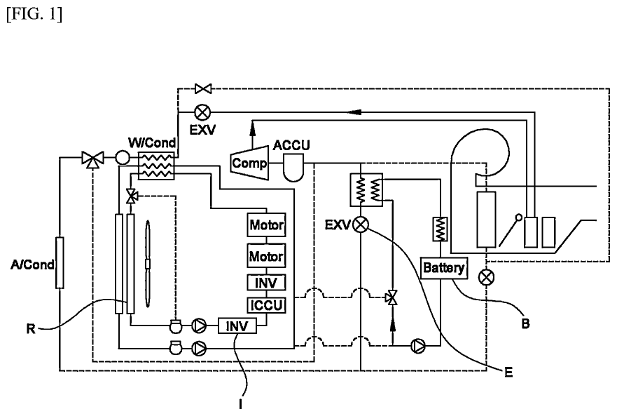

FIG. 2 is a schematic diagram showing a conventional motor cooling method.

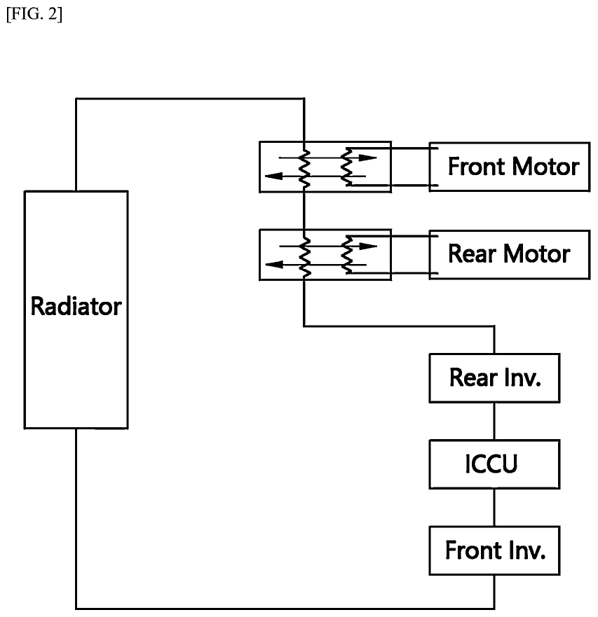

FIG. 3 is a schematic diagram showing a first embodiment of the motor cooling system of the present disclosure.

FIG. 4 is a schematic diagram showing a second embodiment of the motor cooling system of the present disclosure.

FIG. 5 is a schematic diagram showing a third embodiment of the motor cooling system of the present disclosure.

FIG. 6 is a flowchart showing a motor cooling method of the present disclosure.

FIG. 7 is a flowchart showing a detailed operation according to a first embodiment of a path determination operation of the present disclosure.

FIG. 8 is a flowchart showing a detailed operation according to a second embodiment of the path determination operation of the present disclosure.

### DETAILED DESCRIPTION OF EMBODIMENTS

Hereinafter, the technical spirit of the present disclosure is described in more detail with reference to the accompanying drawings. Prior to the description, terms and words used in the specification and claims are not to be construed as general or dictionary meanings, and are to be construed as meanings and concepts meeting the spirit of the present disclosure based on a principle in which the inventors may appropriately define the concepts of the terms in order to describe their inventions in the best mode.

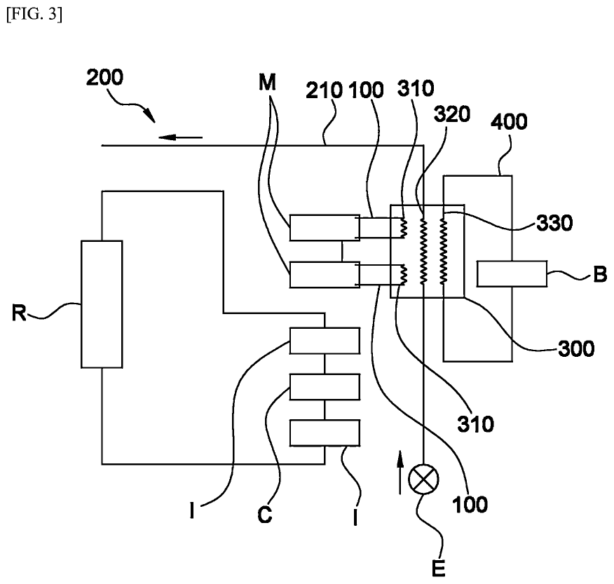

Hereinafter, a motor cooling system 1000 of the present disclosure is described with reference to FIG. 3.

The motor cooling system 1000 of the present disclosure may cool each component of a structure including a battery B and a motor M, and may include a first oil passage part 100, a motor cooling unit 200, and a heat exchange unit 300, as shown in FIG. 3. In more detail, the first oil passage part 100 may pass inside and outside the motor M, and have cooling oil for cooling the motor M flowing therein. In addition, two or more first oil passage parts may be formed, and the first oil passage parts 100 may be applied to two or more motors, which are the front motor M and the rear motor M, respectively. The motor cooling system 1000 may include the first oil passage part 100 to thus cool the cooling oil by heat exchange with the outside of the motor M, and the cooled cooling oil may cool the inside or outside of the motor M.

In addition, the motor cooling unit 200 of the motor cooling system 1000 according to the present disclosure may include a first cooling passage 210 having one side connected to an expansion valve E and receiving a refrigerant from the expansion valve E. The first cooling passage 210 is a passage for cooling a coolant of the battery B, and may have one side connected to the expansion valve E disposed inside the motor M to thus receive the low-temperature and low-pressure refrigerant. In addition, the first cooling passage 210 may have the other side connected to a compressor.

In addition, the heat exchange unit 300 of the motor cooling system 1000 according to the present disclosure may include a first path 310 through which the cooling oil in the first oil passage part 100 passes and a second path 320 through which the refrigerant of the first cooling passage 210 passes. Here, the heat exchange unit 300 may be a chiller. In addition, the first path 310 and the second path 320 may be in direct or indirect contact with each other to exchange heat with each other.

Furthermore, in a first embodiment of the motor cooling system 1000 according to the present disclosure, the heat exchange unit 300 may include a third path 330, through which the cooling oil in a second oil passage part 400 flows, the second oil passage part 400 being applied to the battery B and having the cooling oil for cooling the battery B flowing therein, and the second path 320 having both sides in contact with the first path 310 and the third path 330. Accordingly, the motor cooling system 1000 may cool both the battery B and the motor M by using one first cooling passage 210.

That is, when applying the motor cooling system 1000 of the present disclosure, the motor M may be cooled by a highly efficient cooling system that cools the battery B, in which high heat occurs, instead of being cooled by a radiator R that cools an inverter I and an integrated charging control unit (ICCU) C. Accordingly, the motor cooling system 1000 may achieve a benefit in terms of production efficiency by increasing cooling efficiency of the motor M and also by eliminating any need for additional equipment.

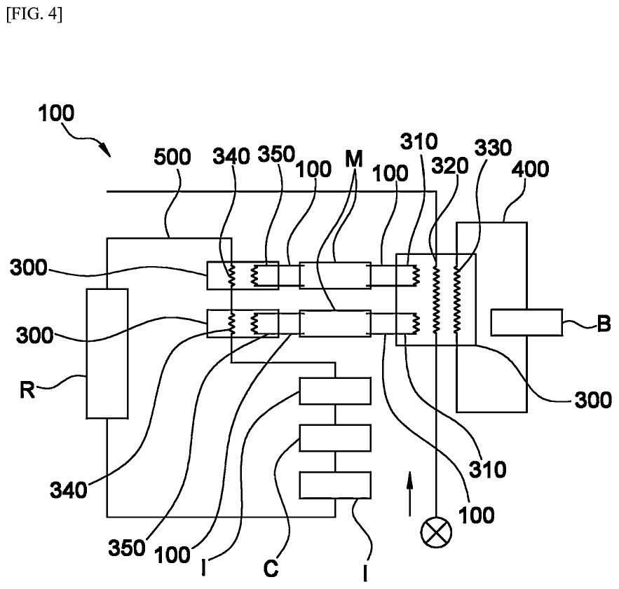

Hereinafter, a second embodiment of the motor cooling system 1000 of the present disclosure is described with reference to FIG. 4.

As shown in FIG. 4, the heat exchange unit 300 may further include a fourth path 340, through which the cooling oil in a third oil passage part 500 passes, the third oil passage part 500 being applied to the inverter I and having the cooling oil for cooling the inverter I flowing therein. Here, the heat exchange unit 300 may also include a fifth path 350, through which the cooling oil in the first oil passage part 100 passes and which is formed separately from the first path 310, and the fourth path 340 and the fifth path 350 may be in direct or indirect contact with each other to exchange heat with each other.

This configuration may have the same cooling path as that of the inverter I or the ICCU (C) by adopting a conventional method of cooling the motor M, and may be performed to prevent excessive use of energy and to prevent the motor M from being overcooled when the motor M has the heat occurrence which is not large enough, that is, when the heat occurrence has a non-dangerous level.

In more detail, in order to control the path through which the cooling oil of the first oil passage part 100 passes, the motor cooling system 1000 of the present disclosure may include a cooling path adjustment unit applied to the first oil passage part 100 to adjust a flow path of the cooling oil. Here, the cooling path adjustment unit may be a valve installed on the first oil passage part 100 and whose opening and closing are adjusted. In addition, the motor cooling system 1000 of the present disclosure may include a sensor unit attached to the motor M and measuring a temperature of the motor M and a control unit controlling the cooling path adjustment unit. The control unit may control the cooling path adjustment unit to adjust the flow path for the cooling oil to pass through the fifth path 350 when the temperature of the motor M that is measured by the sensor unit is less than a predetermined first reference value. According to an exemplary embodiment of the present disclosure, the control unit may include a processor (e.g., computer, microprocessor, CPU, ASIC, circuitry, logic circuits, etc.) and an associated non-transitory memory storing software instructions which, when executed by the processor, provides the functionalities described herein. Herein, the memory and the processor may be implemented as separate semiconductor circuits. Alternatively, the memory and the processor may be implemented as a single integrated semiconductor circuit. The processor may embody one or more processor(s)

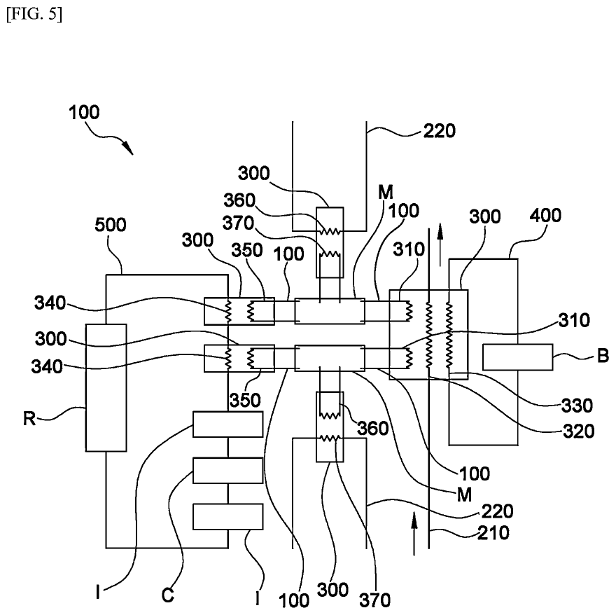

Hereinafter, a third embodiment of the motor cooling system 1000 of the present disclosure is described with reference to FIG. 5.

As shown in FIG. 5, the motor cooling unit may include a second cooling passage 220 through which the refrigerant supplied from the outside flows, and the heat exchange unit 300 may include a sixth path 360 through which the refrigerant of the second cooling passage 220 passes. In addition, the motor cooling unit may include a seventh path 370 through which the cooling oil in the first oil passage part 100 passes and which is formed separately from the first path 310, and the sixth path 360 and the seventh path 370 may be in direct or indirect contact with each other to exchange heat with each other. The sixth path 360 may directly receive the low-temperature and low-pressure refrigerant from the outside, and may cool the motor M more quickly and intuitively by exchanging heat with the seventh path 370.

Accordingly, the control unit may control the cooling path adjustment unit to adjust the flow path for the cooling oil to pass through the seventh path 370 when the temperature of the motor M that is measured by the sensor unit is the first reference value or more and a temperature rise rate of the motor M is a predetermined second reference value or more. Accordingly, the control unit may quickly cool the motor M by using the refrigerant of the second cooling passage 220, which is separately provided, when thermal runaway occurs in the motor M for some reasons.

In addition, the control unit may control the cooling path adjustment unit to adjust the flow path for the cooling oil to pass through the first path 310 when the temperature of the motor M that is measured by the sensor unit is the first reference value or more and the temperature rise rate of the motor M is less than the predetermined second reference value.

In addition, as described above, a drive system included in the electric vehicle may include two or more front motors M applied to its front wheels and two or more rear motors M applied to its rear wheels. Accordingly, the first oil passage parts 100 may respectively be applied to the plurality of motors M, and the sixth path 360 and the seventh path 370 may correspond one-to-one to the respective motors M. Accordingly, a path for independently cooling each motor M may be secured in a case where a temperature deviation occurs between the respective motors M.

In more detail, the control unit may control the cooling path adjustment unit to adjust the flow path for the cooling oil to pass through the seventh path 370 corresponding to the motor M having the highest temperature when a difference between the lowest and highest temperatures of the motors M that are measured by the sensor unit is a predetermined third reference value or more. Here, furthermore, when three or more motors M are applied to the system, the control unit may allow the cooling oil of the first oil passage part 100 to pass through the seventh path 370 corresponding to the motor M having a temperature within a predetermined error range from that of the motor M having the highest temperature.

In addition, the control unit may control the cooling path adjustment unit to adjust the flow path for the cooling oil to pass through the first path 310 when the difference between the lowest and highest temperatures of the motors M that are measured by the sensor unit is less than the predetermined third reference value and the temperature of any one of the motors M is the first reference value or more, and control the cooling path adjustment unit to adjust the flow path for the cooling oil to pass through the fifth path 350 when the difference between the lowest and highest temperatures of the motors M that are measured by the sensor unit is less than the predetermined third reference value and the temperatures of all the motors M are less than the first reference value.

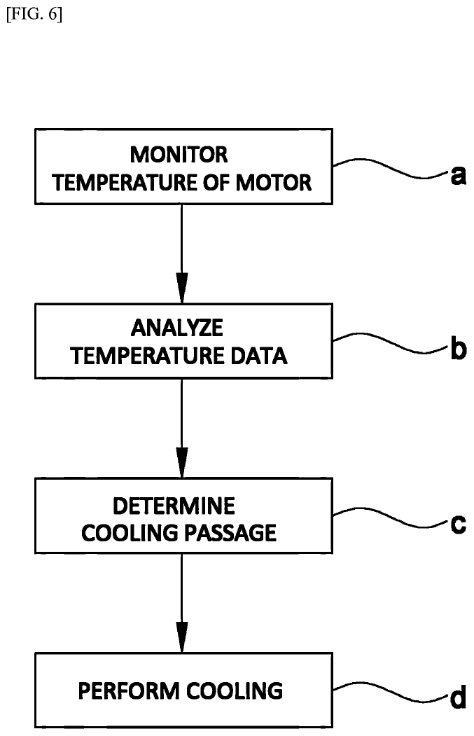

Hereinafter, a motor cooling method of the present disclosure is described in more detail with reference to FIGS. 6 to 8.

The motor cooling method of the present disclosure shown in FIG. 6 may be a motor cooling method using a motor cooling system 1000 applied to a structure including a battery B and a motor M, and may include: an operation (a) of monitoring, by a sensor unit, a temperature of the motor M; an operation (b) of analyzing, by a control unit, temperature data of the sensor unit; an operation (c) of determining, by the control unit, a path of a heat exchange unit 300 through which cooling oil passes based on the analyzed data; and an operation (d) of cooling, by the control unit, the motor M by controlling a cooling path adjustment unit.

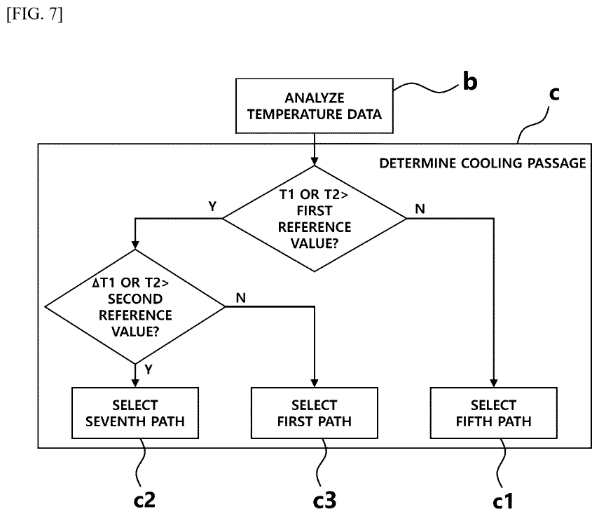

In more detail, as shown in FIG. 7, the operation (c) may include an operation (c1) of controlling the cooling path adjustment unit to adjust a flow path for the cooling oil to pass through a fifth path 350 when a temperature T1 or T2 of the motor M that is analyzed in the operation (b) is less than a predetermined first reference value. Accordingly, the motor M may be cooled by a highly efficient cooling system that cools the battery B, in which high heat occurs, when the motor M has a heat occurrence which is large enough. Accordingly, the motor cooling system 1000 may achieve a benefit in terms of production efficiency by increasing cooling efficiency of the motor M and also by eliminating any need for additional equipment. In addition, this method may be performed to prevent excessive use of energy and to prevent the motor M from being overcooled when the motor M has a heat occurrence which is not large enough, that is, when the heat occurrence is at a non-dangerous level.

In addition, the operation (c) may include an operation (c2) of controlling the cooling path adjustment unit to adjust the flow path for the cooling oil to pass through a seventh path 370 when the temperature T1 or T2 of the motor M that is analyzed in the operation (b) is the first reference value or more, and a temperature rise rate ΔT1 or ΔT2 of the motor M is a predetermined second reference value or more, and an operation (c3) of controlling the cooling path adjustment unit to adjust the flow path for the cooling oil to pass through a first path 310 when the temperature of the motor M that is analyzed in the operation (b) is the first reference value or more, and the temperature rise rate of the motor M is less than the predetermined second reference value. Accordingly, the motor M may be quickly cooled by using a refrigerant of a second cooling passage 220, which is separately provided, when thermal runaway occurs in the motor M, that is, when the temperature rise rate of the motor M is rapidly increased, for some reasons.

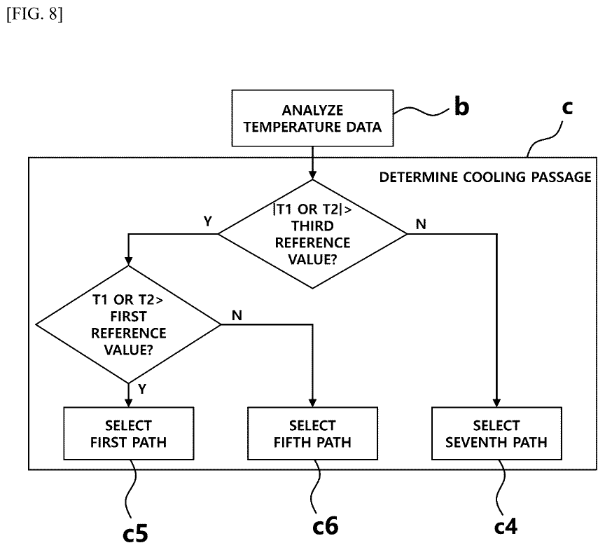

In addition, as shown in FIG. 8, the operation (c) may include an operation (c4) of controlling the cooling path adjustment unit to adjust the flow path for the cooling oil to pass through the seventh path 370 corresponding to the motor M having the highest temperature when a difference |ΔT1−ΔT2| between the lowest and highest temperatures of the motors M that is analyzed in the operation (b) is a third reference value or more.

In more detail, the structure to which the motor cooling system 1000 is applied may include two or more front motors M applied to its front wheels and two or more rear motors M applied to its rear wheels. Therefore, first oil passage parts 100 may respectively be applied to the plurality of motors M, and a sixth path 360 and the seventh path 370 may correspond one-to-one to the respective motors M. Accordingly, a path for independently cooling each motor M may be secured in a case where a temperature deviation occurs between the respective motors M.

In addition, the operation (c) may preferably include: an operation (c5) of controlling the cooling path adjustment unit to adjust the flow path for the cooling oil to pass through the first path 310 when the difference between the lowest and highest temperatures of the motors M that are analyzed in the operation (b) is less than the predetermined third reference value and the temperature T1 or T2 of any one of the motors M is the first reference value or more, and an operation (c6) of controlling the cooling path adjustment unit to adjust the flow path for the cooling oil to pass through the fifth path 350 when the difference between the lowest and highest temperatures of the motors M that are analyzed in the operation (b) is less than the predetermined third reference value and the temperature of any one of the motors M is less than the first reference value.

Accordingly, the motor M may be cooled by the highly efficient cooling system that cools the battery B, in which high heat occurs, when the motor M has the heat occurrence which is large enough. Accordingly, the motor cooling system 1000 may achieve the benefit in terms of the production efficiency by increasing the cooling efficiency of the motor M and also by eliminating any need for additional equipment. In addition, this method may be performed to prevent the excessive use of energy and to prevent the motor M from being overcooled when the motor M has the heat occurrence which is not large enough, that is, when the heat occurrence has the non-dangerous level.

As set forth above, the motor cooling system having the configuration described above and the motor cooling method using the same according to the present disclosure may secure the improved motor efficiency and output by further lowering the temperature of the drive motor cooling oil by establishing the system that achieves the improved cooling effect by changing the medium for lowering the oil temperature from the inverter or integrated charging control unit (ICCU) coolant to the refrigerant used for cooling the coolant of the battery.

The spirit of the present disclosure should not be limited to the embodiments described above. The present disclosure may be applied to various fields and may be variously modified by those skilled in the art without departing from the scope of the present disclosure claimed in the claims. Therefore, it is obvious to those skilled in the art that these alterations and modifications fall within the scope of the present disclosure.

What is claimed is:

1. A motor cooling system, which cools each component of a structure including a battery and a motor, the system comprising:
a first oil passage part having cooling oil for cooling the motor flowing therein;
a motor cooling unit including a first cooling passage having one side connected to an expansion valve and receiving a refrigerant from the expansion valve; and
a heat exchange unit including a first path through which the cooling oil in the first oil passage part passes and a second path through which the refrigerant of the first cooling passage passes,
wherein the first path and the second path are in direct or indirect contact with each other to exchange heat with each other.

2. The system of claim 1, wherein the heat exchange unit includes a third path through which the cooling oil in a second oil passage part flows, the second oil passage part being applied to the battery and having the cooling oil for cooling the battery flowing therein, and
the second path has both sides in contact with the first path and the third path.

3. The system of claim 2, wherein the heat exchange unit includes
a fourth path, through which the cooling oil in a third oil passage part passes, the third oil passage part being applied to an inverter and having the cooling oil for cooling the inverter flowing therein, and
a fifth path, through which the cooling oil in the first oil passage part passes and which is formed separately from the first path, and
the fourth path and the fifth path are in contact with each other to exchange heat with each other.

4. The system of claim 3, wherein the motor cooling unit includes a second cooling passage through which the refrigerant supplied from the outside flows,
the heat exchange unit includes a sixth path through which the refrigerant of the second cooling passage passes, and a seventh path through which the cooling oil in the first oil passage part passes and which is formed separately from the first path, and
the sixth path and the seventh path are in contact with each other to exchange heat with each other.

5. The system of claim 4, further comprising:
a cooling path adjustment unit applied to the first oil passage part to adjust a flow path of the cooling oil;
a sensor unit attached to the motor and measuring a temperature of the motor; and
a control unit controlling the cooling path adjustment unit,
wherein the control unit controls the cooling path adjustment unit to adjust the flow path for the cooling oil to pass through the fifth path when the temperature of the motor that is measured by the sensor unit is less than a predetermined first reference value.

6. The system of claim 5, wherein the control unit controls the cooling path adjustment unit to adjust the flow path for the cooling oil to pass through the seventh path when the temperature of the motor that is measured by the sensor unit is the first reference value or more and a temperature rise rate of the motor is a predetermined second reference value or more, and
controls the cooling path adjustment unit to adjust the flow path for the cooling oil to pass through the first path when the temperature of the motor that is measured by the sensor unit is the first reference value or more and the temperature rise rate of the motor is less than the predetermined second reference value.

7. The system of claim 5, wherein the first oil passage parts are applied to two or more motors,
the sixth path and the seventh path correspond one-to-one to the respective motors,
the control unit controls the cooling path adjustment unit to adjust the flow path for the cooling oil to pass through the seventh path corresponding to the motor having a highest temperature when a difference between lowest and highest temperatures of the motors that are measured by the sensor unit is a predetermined third reference value or more,
controls the cooling path adjustment unit to adjust the flow path for the cooling oil to pass through the first path when the difference between the lowest and highest temperatures of the motors that are measured by the sensor unit is less than the predetermined third reference value and the temperature of any one of the motors is the first reference value or more, and
controls the cooling path adjustment unit to adjust the flow path for the cooling oil to pass through the fifth path when the difference between the lowest and highest temperatures of the motors that are measured by the sensor unit is less than the predetermined third reference value and the temperatures of all the motors are less than the first reference value.

8. A motor cooling method using a motor cooling system applied to a structure including a battery and a motor, the method comprising:
an operation (a) of monitoring, by a sensor unit, a temperature of the motor;
an operation (b) of analyzing, by a control unit, temperature data of the sensor unit;
an operation (c) of determining, by the control unit, a path of a heat exchange unit through which cooling oil passes based on the analyzed data; and
an operation (d) of cooling, by the control unit, the motor by controlling a cooling path adjustment unit.

9. The method of claim 8, wherein the operation (c) includes:
an operation (c1) of controlling the cooling path adjustment unit to adjust a flow path for the cooling oil to pass through a fifth path when the temperature of the motor that is analyzed in the operation (b) is less than a predetermined first reference value,
an operation (c2) of controlling the cooling path adjustment unit to adjust the flow path for the cooling oil to pass through a seventh path when the temperature of the motor that is analyzed in the operation (b) is the first reference value or more, and a temperature rise rate of the motor is a predetermined second reference value or more, and
an operation (c3) of controlling the cooling path adjustment unit to adjust the flow path for the cooling oil to pass through a first path when the temperature of the motor that is analyzed in the operation (b) is the first reference value or more, and the temperature rise rate of the motor is less than the predetermined second reference value.

10. The method of claim 8, wherein the operation (c) includes:
an operation (c4) of controlling the cooling path adjustment unit to adjust the flow path for the cooling oil to pass through the seventh path corresponding to the motor having a highest temperature when a difference between the lowest and highest temperatures of the motors that is analyzed in the operation (b) is a third reference value or more,
an operation (c5) of controlling the cooling path adjustment unit to adjust the flow path for the cooling oil to pass through the first path when the difference between the lowest and highest temperatures of the motors that are analyzed in the operation (b) is less than the predetermined third reference value and the temperature of any one of the motors is the first reference value or more, and
an operation (c6) of controlling the cooling path adjustment unit to adjust the flow path for the cooling oil to pass through the fifth path when the difference between the lowest and highest temperatures of the motors that are analyzed in the operation (b) is less than the predetermined third reference value and the temperature of any one of the motors is less than the first reference value.
